(19) United States
(12) Patent Application Publication
(10) Pub. No.: US 2024/0242093 A1
(43) Pub. Date: Jul. 18, 2024

(54) MACHINE LEARNING BASED SYSTEM FOR PREDICTIVE GENERATION OF DATA PUDDLES

(71) Applicant: BANK OF AMERICA CORPORATION, Charlotte, NC (US)

(72) Inventors: Vijay Kumar Yarabolu, Hyderabad (IN); Gowthaman Sundararaj, Chennai (IN)

(73) Assignee: BANK OF AMERICA CORPORATION, Charlotte, NC (US)

(21) Appl. No.: 18/098,378

(22) Filed: Jan. 18, 2023

(51) Int. Cl. G06N 5/022

(52) U.S. Cl. CPC G06N 5/022

(57) ABSTRACT

Systems, computer program products, and methods are described herein for predictive generation of data puddles. The present disclosure is configured to capture data ingestion information associated with an end-point device over a period of time; determine, using a machine learning (ML) subsystem, data ingestion pattern for the end-point device based on at least the data ingestion information; generate a query sequence for predictive extraction of data from a data lake based on at least the data ingestion pattern; trigger the predictive extraction of the data from the data lake based on at least the query sequence; and store the data in a data puddle associated with the end-point device in response to the predictive extraction.

### TECHNOLOGICAL FIELD

Example embodiments of the present disclosure relate to proactive generation and distribution of data within a computing environment.

### BACKGROUND

Big data ingestion gathers data and brings it into a data processing system where it can be stored, analyzed, and accessed. Data processing systems can include data lakes, databases, and search engines. Typically, this data is unstructured, comes from multiple sources, and exists in diverse formats.

Applicant has identified a number of deficiencies and problems associated with ingestion of big data, and more particularly, generation of data puddles for ingestion by edge devices. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for predictive generation of data puddles.

In one aspect, a system for predictive generation of data puddles is presented. The system comprising: a processing device; a non-transitory storage device containing instructions when executed by the processing device, causes the processing device to perform the steps of: capture data ingestion information associated with an end-point device over a period of time; determine, using a machine learning (ML) subsystem, data ingestion pattern for the end-point device based on at least the data ingestion information; generate a query sequence for predictive extraction of data from a data lake based on at least the data ingestion pattern; trigger the predictive extraction of the data from the data lake based on at least the query sequence; and store the data in a data puddle associated with the end-point device in response to the predictive extraction.

In some embodiments, in determining the data ingestion pattern for the end-point device, the system is configured to: deploy, via the ML subsystem, a trained ML model on the data ingestion information captured over the period of time; and determine, using the trained ML model, the data ingestion pattern for the end-point device.

In some embodiments, the system is configured to: generate a feature set using the data ingestion information captured over the period of time; and train, using the ML subsystem, an ML model using the feature set to generate the trained ML model.

In some embodiments, the system is configured to: determine a likelihood of ingestion associated with one or more components of the data indicating a likelihood that the one or more components of the data will be used by the end-point device; and determine an operational criticality of the one or more components of the data based on at least a type of operation to be performed by the end-point device using the one or more components of the data.

In some embodiments, the system is configured to: determine one or more weights associated with the one or more components of the data based on at least the likelihood of ingestion associated with one or more components of the data and the operational criticality of the one or more components of the data.

In some embodiments, the system is configured to: determine, from the query sequence, an initial order of extraction of the one or more components of the data from the data lake; determine a final order of extraction of the one or more components of the data based on at least the one or more weights; and update the query sequence from the initial order of extraction to the final order of extraction to extract the one or more components of the data from the data lake.

In some embodiments, the data ingestion information is captured from a server log of a fog server associated with the end-point device.

In some embodiments, the system is configured to: receive a request for the data from the end-point device; and transmit, from the data puddle, the data to the end-point device in response to the request for the data, thereby reducing a latency associated with otherwise extracting the data from the data lake in response to the request for the data.

In another aspect, a computer program product for predictive generation of data puddles is presented. The computer program product comprising a non-transitory computer-readable medium comprising code causing an apparatus to: capture data ingestion information associated with an end-point device over a period of time; determine, using a machine learning (ML) subsystem, data ingestion pattern for the end-point device based on at least the data ingestion information; generate a query sequence for predictive extraction of data from a data lake based on at least the data ingestion pattern; trigger the predictive extraction of the data from the data lake based on at least the query sequence; and store the data in a data puddle associated with the end-point device in response to the predictive extraction.

In yet another aspect, a method for predictive generation of data puddles is presented. The method comprising: capturing data ingestion information associated with an end-point device over a period of time; determining, using a machine learning (ML) subsystem, data ingestion pattern for the end-point device based on at least the data ingestion information; generating a query sequence for predictive extraction of data from a data lake based on at least the data ingestion pattern; triggering the predictive extraction of the data from the data lake based on at least the query sequence; and storing the data in a data puddle associated with the end-point device in response to the predictive extraction.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIG. 1 illustrates technical components of an exemplary computing environment for predictive generation of data puddles, in accordance with an embodiment of the disclosure.

FIG. 2 illustrates an exemplary component-level structure of the system 108, in accordance with an embodiment of the disclosure.

FIG. 3 illustrates a method for predictive generation of data puddles, in accordance with an embodiment of the disclosure.

FIG. 4 illustrates a method for determining the order of extraction of data components, in accordance with an embodiment of the invention.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

During operations, data requests from end-point devices are typically fulfilled by the data lake. This involves routing the data request through the fog server to retrieve the requisite data from the data lake to be stored in the corresponding data puddle. In time sensitive operations, such as ML training sequences, requiring each data request to be fulfilled by the data lake may cause latency issues in the request-response process. Such latency issues often have a cascading effect that affects the operations performed by the end-point device. By identifying specific data requirements for the end-point device using the data ingestion patterns, the present disclosure may be able to generate a query sequence to predictively retrieve the requisite data for the end-point device from the data lake preemptively and store the data in the data puddle for the fog server to access quickly. Therefore, in response to a request for data from the end-point device, the system may trigger a transmission of the data from the data puddle to the end-point device, thereby reducing a latency associated with otherwise extracting the data from the data lake. Accordingly, the query sequence may not only define the data required but also define a particular order in which the data is to be retrieved from the data lake. What is more, the present disclosure provides a technical solution to a technical problem. The technical solution described herein uses a rigorous, computerized process to perform specific tasks and/or activities that were not previously performed. In specific implementations, the technical solution bypasses a series of steps previously implemented, thus further conserving computing resources.

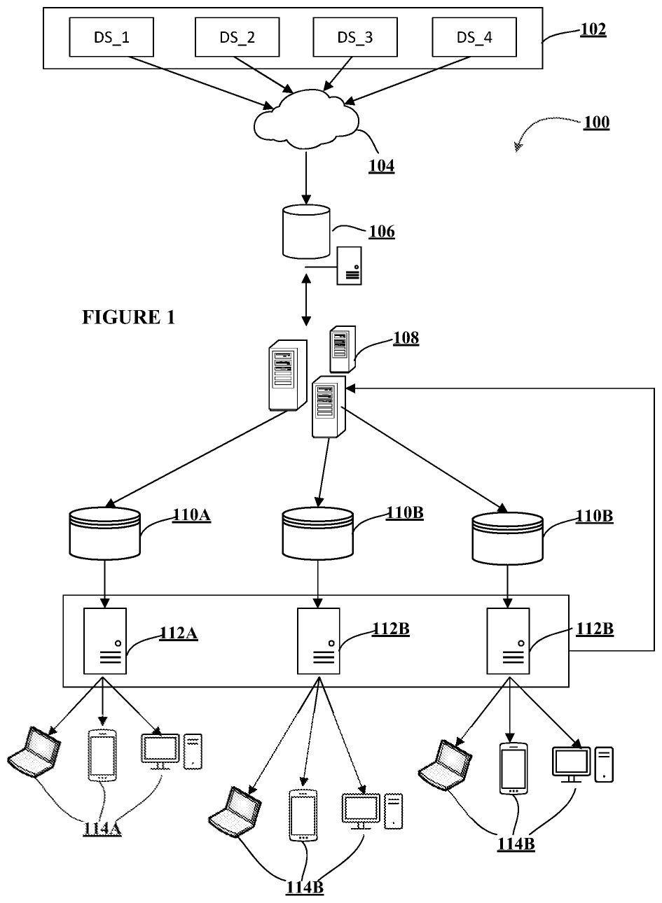

FIG. 1 illustrates technical components of an exemplary computing environment for predictive generation of data puddles 100, in accordance with an embodiment of the disclosure. As shown in FIG. 1, the distributed computing environment 100 contemplated herein may include data sources DS_1, DS_2, DS_3, DS_4 102, a centralized cloud data center 104, a data lake 106, a system 108, data puddles 110A, 110B, 110C, fog servers 112A, 112B, 112C, end-point devices 114A, 114B, and 114C. FIG. 1 illustrates only one example of an embodiment of the computing environment 100, and it will be appreciated that in other embodiments one or more of the systems, data centers, data lakes, data puddles, devices, and/or servers may be combined into a single system, device, or server, or be made up of multiple systems, devices, or servers. Also, the computing environment 100 may include multiple systems, same or similar to system 108, with each system providing portions of the necessary operations (e.g., as a server bank, a group of blade servers, or a multi-processor system).

The data sources DS_1, DS_2, DS_3, DS_4 102 may refer to a primary location from where the data is gathered. In other words, data sources DS_1, DS_2, DS_3, DS_4 102 may include a database, a flat file, live measurements from physical devices, scraped web data, or any of the myriad static and streaming data services which abound across the computing environment and beyond (e.g., Internet). Data retrieved from the data sources DS_1, DS_2, DS_3, DS_4 102 may have varying file formats that defines the structure and encoding of the data stored therein and is identified by its file extension. However, some data sources DS_1, DS_2, DS_3, DS_4 102 generate data that is not in a format that can be directly used for processing. The data from each of the data sources DS_1, DS_2, DS_3, DS_4 102 is funneled into the centralized cloud data center 104 for storage.

The centralized cloud data center 104 may be a database that is located, stored, and maintained in a single location where files, data and databases can be shared between various components in the computing network. In some embodiments, the centralized cloud data center 104 may receive the data from the data sources DS_1, DS_2, DS_3, DS_4 102 and implement initial data integration and processing steps needed to prepare the data for use. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other data processing steps as needed. In some other embodiments, the centralized cloud data center 104 may receive the data from the data sources DS_1, DS_2, DS_3, DS_4 102 and store the data as is without implementing any additional data integration and processing steps.

In large entities with varying lines of businesses, the data requirement for each line of business may be vastly different. Each line of business may be associated with a dedicated data lake (e.g., data lake 106), which provides data for operations specific to that line of business. Accordingly, the data lake 106 may be a data repository comprising object blobs or files, including raw copies of source system data, sensor data, social data and/or the like, and transformed data used for tasks such as reporting, visualization, advanced analytics, machine learning, and/or the like. As such, the data lake 106 may include structured data from relational databases (rows and columns), semi-structured data (CSV, logs, XML, JSON), unstructured data (emails, documents, PDFs) and binary data (images, audio, video). The data lake 106 may be configured to provide the necessary data to various data puddles (e.g., data puddle 110A, 110B, 110C).

Each line of business in a large entity may have a number of project-lines that perform dedicated operations. Most of these operations require large amount of data. While each line of business may have a dedicated data lake (e.g., data lake 106), each project-line may have a dedicated data puddle (e.g., data puddle 110A) that stores data specific to operations performed by that project-line. As such, each data lake (e.g., data lake 106) may be configured to store and provide necessary data to each project-line. Accordingly, the data lake 106 may serve one or more data puddles (e.g., data puddles 110A, 110B, 110C), where each data puddle is dedicated to a project-line.

Each project-line may include a dedicated fog server (e.g., fog server 112A) configured to manage data distribution from the associated data puddle (e.g., data puddle 110A) to one or more end-point devices (e.g., end-point device 114A) associated therewith. Each end-point device 114A may be configured to perform dedicated operations for the associated project-line. When performing such operations, the end-point devices 114A may require project-specific data. In such situations, the end-point devices 114A may transmit a data request to the fog server 112A associated therewith. The fog server 112A may in turn retrieve the necessary data from the associated data puddle 110A and provide the data to the end-point devices 114A. Similarly, end-point devices 114B may transmit a data request to the fog server 112B associated therewith. The fog server 112B may in turn retrieve the necessary data from the associated data puddle 110B and provide the data to the end-point device 114B. Similarly, end-point devices 114C may transmit a data request to the fog server 112C associated therewith. The fog server 112C may in turn retrieve the necessary data from the associated data puddle 110C and provide the data to the end-point devices 114C. As described herein, the system 108 may receive data ingestion information associated with the end-point devices 114A, 114B, 114C from corresponding fog servers 112A, 112B, 112C. The data ingestion information is then used to predict the data required by each of the end-point devices 114A, 114B, 114C from the data lake 106. The data is then preemptively retrieved from the data lake 106 and stored in the corresponding data puddle 110A, 110B, 110C for the fog servers 112A, 112B, 112C to access quickly.

The end-point devices 114A, 114B, 114C may be may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

In some embodiments, the system 108 may have a client-server relationship with various components in the computing environment 100, such as the data centers, data lakes, data puddles, end-point devices, and/or servers, in which the system 108 receives a request from the components and subsequently provides service thereto. In some other embodiments, the system 108 may have a peer-to-peer relationship with the components in which the system 108 and the components are considered equal, and all have the same abilities to use the resources. Instead of having a central server (e.g., system 108) which would act as the shared drive, each component would act as the server for the files stored on it.

The system 108 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

In some embodiments, the system 108 and the various components in the computing environment 100 may communicate using a network (not shown). The network may be a distributed network that is spread over different networks. This provides a single data communication network, which can be managed jointly or separately by each network. Besides shared communication within the network, the distributed network often also supports distributed processing. The network may be a form of digital communication network such as a telecommunication network, a local area network (“LAN”), a wide area network (“WAN”), a global area network (“GAN”), the Internet, or any combination of the foregoing. The network 210 may be secure and/or unsecure and may also include wireless and/or wired and/or optical interconnection technology.

It is to be understood that the structure of the computing environment and its components, connections and relationships, and their functions, are meant to be exemplary only, and are not meant to limit implementations of the disclosures described and/or claimed in this document. In one example, the computing environment 100 may include more, fewer, or different components. In another example, some or all of the portions of the computing environment 100 may be combined into a single portion or all of the portions of the system 108 may be separated into two or more distinct portions.

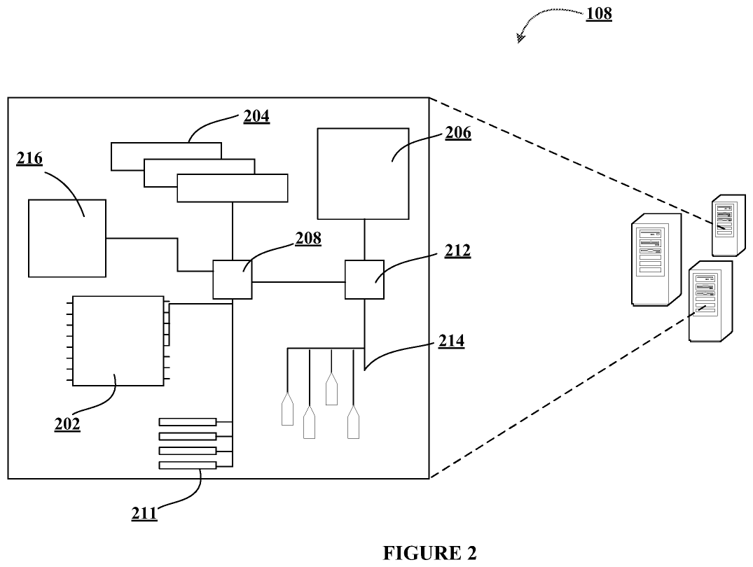

FIG. 2 illustrates an exemplary component-level structure of the system 108, in accordance with an embodiment of the disclosure. As shown in FIG. 1B, the system 108 may include a processor 202, memory 204, input/output (I/O) device 216, and a storage device 210. The system 108 may also include a high-speed interface 208 connecting to the memory 204, and a low-speed interface 212 connecting to low speed bus 214 and storage device 210. Each of the components 202, 204, 208, 210, and 212 may be operatively coupled to one another using various buses and may be mounted on a common motherboard or in other manners as appropriate. As described herein, the processor 202 may include a number of subsystems to execute the portions of processes described herein. Each subsystem may be a self-contained component of a larger system (e.g., system 108) and capable of being configured to execute specialized processes as part of the larger system.

The processor 202 can process instructions, such as instructions of an application that may perform the functions disclosed herein. These instructions may be stored in the memory 204 (e.g., non-transitory storage device) or on the storage device 210, for execution within the system 108 using any subsystems described herein. It is to be understood that the system 108 may use, as appropriate, multiple processors, along with multiple memories, and/or I/O devices, to execute the processes described herein.

The memory 204 stores information within the system 108. In one implementation, the memory 204 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 204 is a non-volatile memory unit or units. The memory 204 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 204 may store, recall, receive, transmit, and/or access various files and/or information used by the system 108 during operation.

The storage device 206 is capable of providing mass storage for the system 108. In one aspect, the storage device 206 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 204, the storage device 204, or memory on processor 202.

The high-speed interface 208 manages bandwidth-intensive operations for the system 108, while the low speed controller 212 manages lower bandwidth-intensive operations. Such allocation of functions is exemplary only. In some embodiments, the high-speed interface 208 is coupled to memory 204, input/output (I/O) device 216 (e.g., through a graphics processor or accelerator), and to high-speed expansion ports 111, which may accept various expansion cards (not shown). In such an implementation, low-speed controller 212 is coupled to storage device 206 and low-speed expansion port 214. The low-speed expansion port 214, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 108 may be implemented in a number of different forms. For example, the system 108 may be implemented as a standard server, or multiple times in a group of such servers. Additionally, the system 108 may also be implemented as part of a rack server system or a personal computer such as a laptop computer. Alternatively, components from system 108 may be combined with one or more other same or similar systems and an entire system 108 may be made up of multiple computing devices communicating with each other.

Various implementations of the distributed computing environment 100, including the system 108 and end-point device(s) 140, and techniques described here can be realized in digital electronic circuitry, integrated circuitry, specially designed ASICs (application specific integrated circuits), computer hardware, firmware, software, and/or combinations thereof.

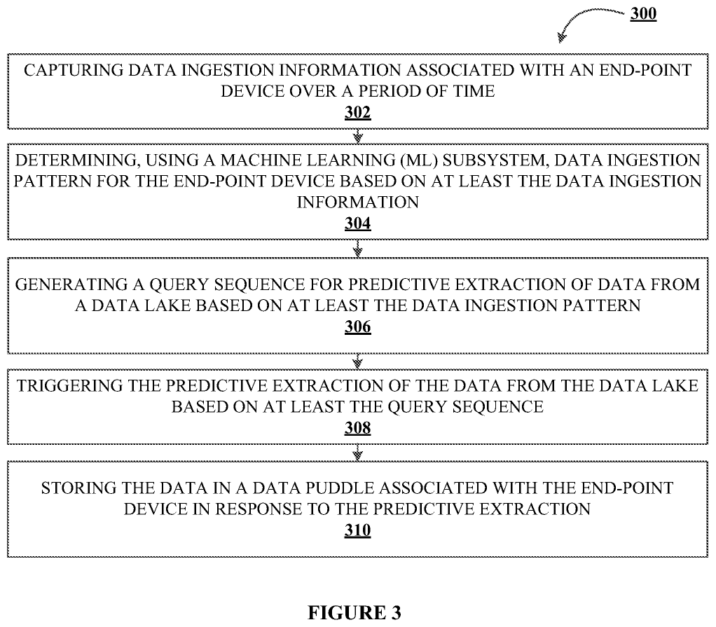

FIG. 3 illustrates a method for predictive generation of data puddles, in accordance with an embodiment of the disclosure. As shown in block 302, the method includes capturing data ingestion information associated with an end-point device over a period of time. In some embodiments, the data ingestion information associated with a specific end-point device may be recorded in the associated fog server in the form of a server log. As such, the data ingestion information may include network telemetry data—including flow data and Simple Network Management Protocol (SNMP) data, application recognition data—used to classify and regulate bandwidth requirement for specific applications that are executed on the end-point device, application visibility and control data—including TCP performance metrics such as bandwidth use, response time, and latency, and RTP performance metrics including packet loss and jitter, Application Programming Interface (API) data and packet capture data providing insight into traffic routing, end-point device utilization data, data reflecting end-point device capacity limitations, and/or the like. In addition, the data ingestion information may also include IP address and identity of the end-point device making a request, name, location and size of the requested data, time and date of the request, and the request method, status code associated with the request, and/or the like.

Next, as shown in block 304, the method includes determining, using a machine learning (ML) subsystem, data ingestion pattern for the end-point device based on at least the data ingestion information. To this end, in some embodiments, the system may deploy, via the ML subsystem, a trained ML model on the data ingestion information captured over the period of time. A trained ML model may refer to a mathematical model generated by machine learning algorithms based on training data, to make predictions or decisions without being explicitly programmed to do so. To train the ML model, the system may use the data ingestion information as training data to identify data ingestion patterns associated with the end-point device.

The ML model represents what was learned by the selected machine learning algorithm and represents the rules, numbers, and any other algorithm-specific data structures required for decision-making. Selecting the right machine learning algorithm may depend on a number of different factors, such as the problem statement and the kind of output needed, type and size of the data, the available computational time, number of features and observations in the data, and/or the like. ML algorithms may refer to programs that are configured to self-adjust and perform better as they are exposed to more data. To this extent, ML algorithms are capable of adjusting their own parameters, given feedback on previous performance in making prediction about a dataset.

The ML algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

The ML model may be trained using repeated execution cycles of experimentation, testing, and tuning to modify the performance of the ML algorithm and refine the results in preparation for deployment of those results for consumption or decision making. The ML model may be tuned by dynamically varying hyperparameters in each iteration (e.g., number of trees in a tree-based algorithm or the value of alpha in a linear algorithm), running the algorithm on the data again, and then comparing its performance on a validation set to determine which set of hyperparameters results in the most accurate model. The accuracy of the model is the measurement used to determine which set of hyperparameters is best at identifying relationships and patterns between variables in a dataset based on the input, or training data. A fully trained ML model is one whose hyperparameters are tuned and model accuracy maximized. When deployed, the trained ML model may be used to determine the data ingestion pattern for the end-point device.

Next, as shown in block 306, the method includes generating a query sequence for predictive extraction of data from a data lake based on at least the data ingestion pattern. In some embodiments, the data ingestion pattern may refer to data regularities and patterns in the data ingestion information identifying specific data requirements for the end-point device. Next, as shown in block 308, the method includes triggering the predictive extraction of the data from the data lake based on at least the query sequence. Next, as shown in block 310, the method includes storing the data in a data puddle associated with the end-point device in response to the predictive extraction.

As described herein, during operations, data requests from end-point devices are typically fulfilled by the data lake. This involves routing the data request through the fog server to retrieve the requisite data from the data lake to be stored in the corresponding data puddle. In time sensitive operations, such as ML training sequences, requiring each data request to be fulfilled by the data lake may cause latency issues in the request-response process. Such latency issues often have a cascading effect that affects the operations performed by the end-point device. By identifying specific data requirements for the end-point device using the data ingestion patterns, the system may be able to generate a query sequence to predictively retrieve the requisite data for the end-point device from the data lake preemptively, and store the data in the data puddle for the fog server to access quickly. Therefore, in response to a request for data from the end-point device, the system may trigger a transmission of the data from the data puddle to the end-point device, thereby reducing a latency associated with otherwise extracting the data from the data lake. Accordingly, the query sequence may not only define the data required but also define a particular order in which the data is to be retrieved from the data lake.

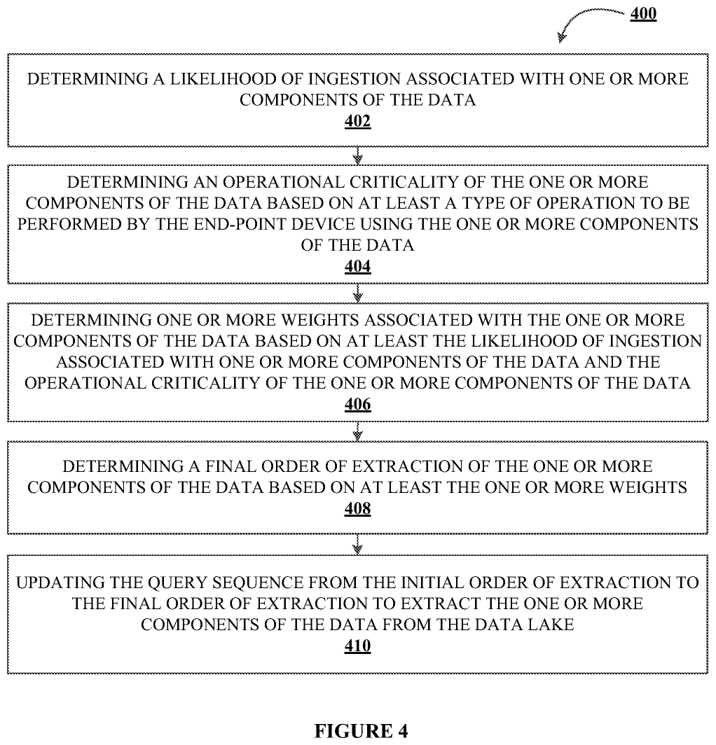

FIG. 4 illustrates a method for determining the order of extraction of data components, in accordance with an embodiment of the invention. As shown in block 402, the method includes determining a likelihood of ingestion associated with one or more components of the data. In some embodiments, the data may comprise of one or more components, with each component being used for a specific purpose (e.g., operation) by the end-point device. In some embodiments, the likelihood of ingestion may indicate a likelihood that the one or more components of the data will be used by the end-point device.

Next, as shown in block 404, the method includes determining an operational criticality of the one or more components of the data based on at least a type of operation to be performed by the end-point device using the one or more components of the data. In some embodiments, the operational criticality of a particular data component may be determined based on how, when, and for what operation the data component is being used for. For example, data components that are being used in the encryption-decryption process may be categorized as having a high operational criticality; data components that are being used to populate a graphical interface may have low operational criticality; data components that are being used to train an ML model may have a high operational criticality; data components that are being used to classify unseen data using the trained ML model may have a low operational criticality. In other words, operations that are sensitive to data latency issues are typically classified as having high operational criticality, while operations that have are less sensitive to data latency issues are classified as having low operational criticality. In some embodiments, the operational criticality may be numerically quantified.

Next, as shown in block 406, the method includes determining one or more weights associated with the one or more components of the data based on at least the likelihood of ingestion associated with one or more components of the data and the operational criticality of the one or more components of the data. In some embodiments, the weights may be determined based on an analytical determination that uses both the likelihood of ingestion and the operational criticality. For example, the weight of a data component may be determined by dividing the operational criticality by the likelihood of ingestion.

Next, as shown in block 408, the method includes determining a final order of extraction of the one or more components of the data based on at least the one or more weights. In some embodiments, the final order of the extraction of the data components may be determined based on an ascending order of the weights.

Next, as shown in block 410, the method includes updating the query sequence from the initial order of extraction to the final order of extraction to extract the one or more components of the data from the data lake. In some embodiments, the system may determine, from the query sequence, an initial order of extraction of the one or more components of the data from the data lake. The initial order of extraction may reflect the sequence in which the one or more components of the data are retrieved from the data lake. The earlier a data component is retrieved, the quicker it may be made available to the data puddle. Therefore, applications that have lower tolerance to latency may require their associated data components to be retrieved earlier. By weighting the data components using the one or more weights, the system may determine a final order of extraction, and subsequently update the query sequence to reflect the final order of extraction.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for predictive generation of data puddles, the system comprising:
a processing device;
a non-transitory storage device containing instructions when executed by the processing device, causes the processing device to perform the steps of:
capture data ingestion information associated with an end-point device over a period of time;
determine, using a machine learning (ML) subsystem, data ingestion pattern for the end-point device based on at least the data ingestion information;
generate a query sequence for predictive extraction of data from a data lake based on at least the data ingestion pattern;
trigger the predictive extraction of the data from the data lake based on at least the query sequence; and
store the data in a data puddle associated with the end-point device in response to the predictive extraction.

2. The system of claim 1, wherein, in determining the data ingestion pattern for the end-point device, the system is configured to:
deploy, via the ML subsystem, a trained ML model on the data ingestion information captured over the period of time; and
determine, using the trained ML model, the data ingestion pattern for the end-point device.

3. The system of claim 2, wherein the system is configured to:
generate a feature set using the data ingestion information captured over the period of time; and
train, using the ML subsystem, an ML model using the feature set to generate the trained ML model.

4. The system of claim 1, wherein the system is configured to:
determine a likelihood of ingestion associated with one or more components of the data indicating a likelihood that the one or more components of the data will be used by the end-point device; and
determine an operational criticality of the one or more components of the data based on at least a type of operation to be performed by the end-point device using the one or more components of the data.

5. The system of claim 4, wherein the system is configured to:
determine one or more weights associated with the one or more components of the data based on at least the likelihood of ingestion associated with one or more components of the data and the operational criticality of the one or more components of the data.

6. The system of claim 5, wherein the system is configured to:
determine, from the query sequence, an initial order of extraction of the one or more components of the data from the data lake;
determine a final order of extraction of the one or more components of the data based on at least the one or more weights; and
update the query sequence from the initial order of extraction to the final order of extraction to extract the one or more components of the data from the data lake.

7. The system of claim 1, wherein the data ingestion information is captured from a server log of a fog server associated with the end-point device.

8. The system of claim 1, wherein the system is configured to:
receive a request for the data from the end-point device; and
transmit, from the data puddle, the data to the end-point device in response to the request for the data, thereby reducing a latency associated with otherwise extracting the data from the data lake in response to the request for the data.

9. A computer program product for predictive generation of data puddles, the computer program product comprising a non-transitory computer-readable medium comprising code causing an apparatus to:
capture data ingestion information associated with an end-point device over a period of time;
determine, using a machine learning (ML) subsystem, data ingestion pattern for the end-point device based on at least the data ingestion information;
generate a query sequence for predictive extraction of data from a data lake based on at least the data ingestion pattern;
trigger the predictive extraction of the data from the data lake based on at least the query sequence; and
store the data in a data puddle associated with the end-point device in response to the predictive extraction.

10. The computer program product of claim 9, wherein, in determining the data ingestion pattern for the end-point device, the computer program product is configured to:
deploy, via the ML subsystem, a trained ML model on the data ingestion information captured over the period of time; and
determine, using the trained ML model, the data ingestion pattern for the end-point device.

11. The computer program product of claim 10, wherein the computer program product is configured to:
generate a feature set using the data ingestion information captured over the period of time; and
train, using the ML subsystem, an ML model using the feature set to generate the trained ML model.

12. The computer program product of claim 9, wherein the computer program product is configured to:
determine a likelihood of ingestion associated with one or more components of the data indicating a likelihood that the one or more components of the data will be used by the end-point device; and
determine an operational criticality of the one or more components of the data based on at least a type of operation to be performed by the end-point device using the one or more components of the data.

13. The computer program product of claim 12, wherein the computer program product is configured to:
determine one or more weights associated with the one or more components of the data based on at least the likelihood of ingestion associated with one or more components of the data and the operational criticality of the one or more components of the data.

14. The computer program product of claim 13, wherein the computer program product is configured to:
determine, from the query sequence, an initial order of extraction of the one or more components of the data from the data lake;
determine a final order of extraction of the one or more components of the data based on at least the one or more weights; and
update the query sequence from the initial order of extraction to the final order of extraction to extract the one or more components of the data from the data lake.

15. The computer program product of claim 9, wherein the data ingestion information is captured from a server log of a fog server associated with the end-point device.

16. The computer program product of claim 9, wherein the computer program product is configured to:
receive a request for the data from the end-point device; and
transmit, from the data puddle, the data to the end-point device in response to the request for the data, thereby reducing a latency associated with otherwise extracting the data from the data lake in response to the request for the data.

17. A method for predictive generation of data puddles, the method comprising:
capturing data ingestion information associated with an end-point device over a period of time;
determining, using a machine learning (ML) subsystem, data ingestion pattern for the end-point device based on at least the data ingestion information;
generating a query sequence for predictive extraction of data from a data lake based on at least the data ingestion pattern;
triggering the predictive extraction of the data from the data lake based on at least the query sequence; and
storing the data in a data puddle associated with the end-point device in response to the predictive extraction.

18. The method of claim 17, wherein, in determining the data ingestion pattern for the end-point device, the method further comprises:
deploying, via the ML subsystem, a trained ML model on the data ingestion information captured over the period of time; and
determining, using the trained ML model, the data ingestion pattern for the end-point device.

19. The method of claim 18, wherein the method further comprises:
generating a feature set using the data ingestion information captured over the period of time; and
training, using the ML subsystem, an ML model using the feature set to generate the trained ML model.

20. The method of claim 17, wherein the method further comprises:
determining a likelihood of ingestion associated with one or more components of the data indicating a likelihood that the one or more components of the data will be used by the end-point device; and
determining an operational criticality of the one or more components of the data based on at least a type of operation to be performed by the end-point device using the one or more components of the data.
